(19) United States
(12) Patent Application Publication
(10) Pub. No.: US 2025/0054243 A1
(43) Pub. Date: Feb. 13, 2025

(54) Two-Dimensional User Interface Content Overlay for an Artificial Reality Environment

(71) Applicant: Meta Platforms Technologies, LLC, Menlo Park, CA (US)

(72) Inventors: Aaron SELIG, Belmont, CA (US); Kristel Andrea ARANDA SUAREZ, Los Gatos, CA (US); Ryan WALTON, San Francisco, CA (US)

(21) Appl. No.: 18/448,196

(22) Filed: Aug. 11, 2023

(51) Int. Cl. G06T 19/00; G06F 11/34; G06T 11/60

(52) U.S. Cl. CPC G06T 19/006; G06F 11/3438; G06T 11/60

(57) ABSTRACT

Aspects of the present disclosure are directed to a two-dimensional (2D) user interface (UI) content overlay for an artificial reality (XR) environment. In some implementations, the content overlay can be a default home screen when a user launches into an immersive XR application that helps the user navigate and control immersive destinations, and complete relevant and frequent actions related to the XR application. In some implementations, the content overlay can serve dynamic content based on the user's context to help them, e.g., A) find and play with other users, B) learn relevant actions that can be taken, C) quickly travel to a destination, D) see relevant content, etc. The content overlay can provide these functions 2D cards in the XR environment, which can be specific to the executing XR application, or can be system-level for multiple providing content XR applications.

### TECHNICAL FIELD

The present disclosure is directed to providing a two-dimensional (2D) content overlay for an artificial reality (XR) environment on an XR device.

### BACKGROUND

Artificial reality (XR) devices are becoming more prevalent. As they become more popular, the applications implemented on such devices are becoming more sophisticated. Augmented reality (AR) applications can provide interactive 3D experiences that combine images of the real-world with virtual objects, while virtual reality (VR) applications can provide an entirely self-contained 3D computer environment. For example, an AR application can be used to superimpose virtual objects over a video feed of a real scene that is observed by a camera. A real-world user in the scene can then make gestures captured by the camera that can provide interactivity between the real-world user and the virtual objects. Mixed reality (MR) systems can allow light to enter a user's eye that is partially generated by a computing system and partially includes light reflected off objects in the real-world. AR, MR, and VR (together XR) experiences can be observed by a user through a head-mounted display (HMD), such as glasses or a headset. An MR HMD can have a pass-through display, which allows light from the real-world to pass through a lens to combine with light from a waveguide that simultaneously emits light from a projector in the MR HMD, allowing the MR HMD to present virtual objects intermixed with real objects the user can actually see.

### BRIEF DESCRIPTION OF THE DRAWINGS

FIG. 1 is a block diagram illustrating an overview of devices on which some implementations of the present technology can operate.

FIG. 2A is a wire diagram illustrating a virtual reality headset which can be used in some implementations of the present technology.

FIG. 2B is a wire diagram illustrating a mixed reality headset which can be used in some implementations of the present technology.

FIG. 2C is a wire diagram illustrating controllers which, in some implementations, a user can hold in one or both hands to interact with an artificial reality environment.

FIG. 3 is a block diagram illustrating an overview of an environment in which some implementations of the present technology can operate.

FIG. 4 is a block diagram illustrating components which, in some implementations, can be used in a system employing the disclosed technology.

FIG. 5 is a flow diagram illustrating a process used in some implementations of the present technology for providing a two-dimensional user interface content overlay in an artificial reality environment.

FIG. 6 is a block diagram illustrating a system of inputs to, and outputs from, an artificial reality system runtime, executing on an artificial reality device, to provide a two-dimensional user interface content overlay for an artificial reality application.

FIG. 7 is a flow diagram illustrating a process used in some implementations for locally applying and updating a trained model for ranking user interface cards according to some implementations of the present technology.

FIG. 8A is a conceptual diagram illustrating an example view, on an artificial reality device, of a two-dimensional user interface content overlay as a home screen.

FIG. 8B is a conceptual diagram illustrating an example view, on an artificial reality device, of highlights cards in a two-dimensional user interface content overlay for an artificial reality application.

FIG. 8C is a conceptual diagram illustrating an example view, on an artificial reality device, of achievements cards in a two-dimensional user interface content overlay for an artificial reality application.

FIG. 9 is a conceptual diagram illustrating an example view, on an artificial reality device, of social and avatar cards in a two-dimensional user interface content overlay for an artificial reality application.

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure are directed to a two-dimensional (2D) user interface (UI) content overlay for an artificial reality (XR) environment. In some implementations, the content overlay can be a default home screen when a user launches into an immersive XR application that helps the user navigate and control immersive destinations, and complete relevant and frequent actions related to the XR application. In some implementations, the content overlay can serve dynamic content based on the user's context to help them, e.g., A) find and play with other users, B) learn relevant actions that can be taken, C) quickly travel to a destination, D) see relevant content, etc.

The content overlay can provide these functions via a series of 2D cards in the XR environment, which can be specific to the executing XR application, and/or can be system-level providing content for multiple XR applications (e.g., social content). Using inter-process communication, some implementations can create the 2D cards with dynamic content including parameters for their configuration based on user context, and can apply a filtering and ranking process for the cards eligible to be shown, e.g., based on availability of information, relevance, by applying randomization, etc.

Embodiments of the disclosed technology may include or be implemented in conjunction with an artificial reality system. Artificial reality or extra reality (XR) is a form of reality that has been adjusted in some manner before presentation to a user, which may include, e.g., virtual reality (VR), augmented reality (AR), mixed reality (MR), hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof.

The implementations described herein provide specific technological improvements in the field of artificial reality. Conventionally, system-level and application-level menus and data are provided and rendered separately. Implementations of the present disclosure, however, provide for a composite user interface menu, including integrated application- and system-level data and functions, by utilizing inter process communications between the XR system runtime and the XR application runtime. While the XR application runtime is controlling and managing the non-native XR environment, the XR system runtime can control and execute native operating system-level procedures, with both providing data streams indicative of their executed functions. Implementations can transform these data streams into two-dimensional renderable content, weighted and organized using a heuristic or machine learning model. Implementations can further render a composite 2D graphical user interface overlay for the XR environment that includes both system- and application-generated data and functions, thereby reducing the number of menus needed to be separately accessed and rendered. By providing such simplification, the implementations provided herein can result in less processing, storage, and power resources consumed on the XR device to access disparately provided data and perform disparately controlled functions.

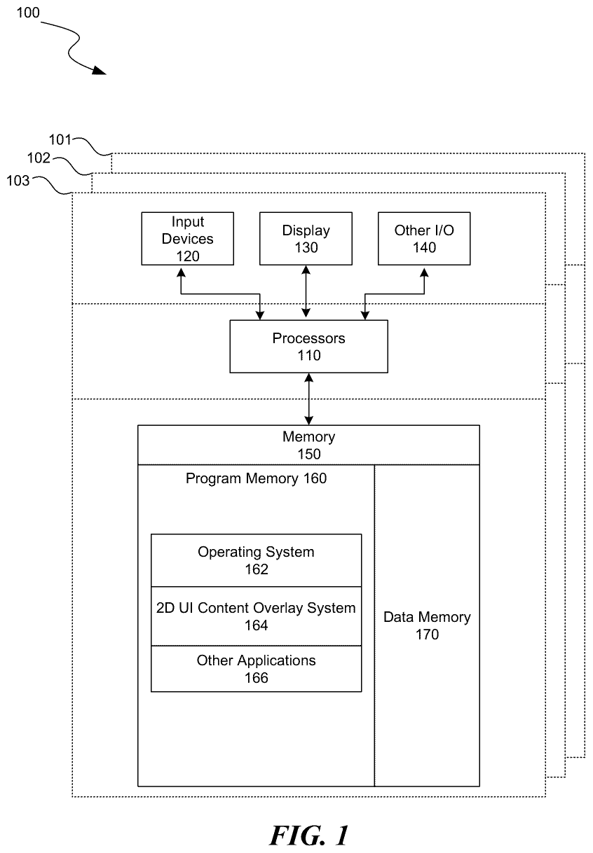

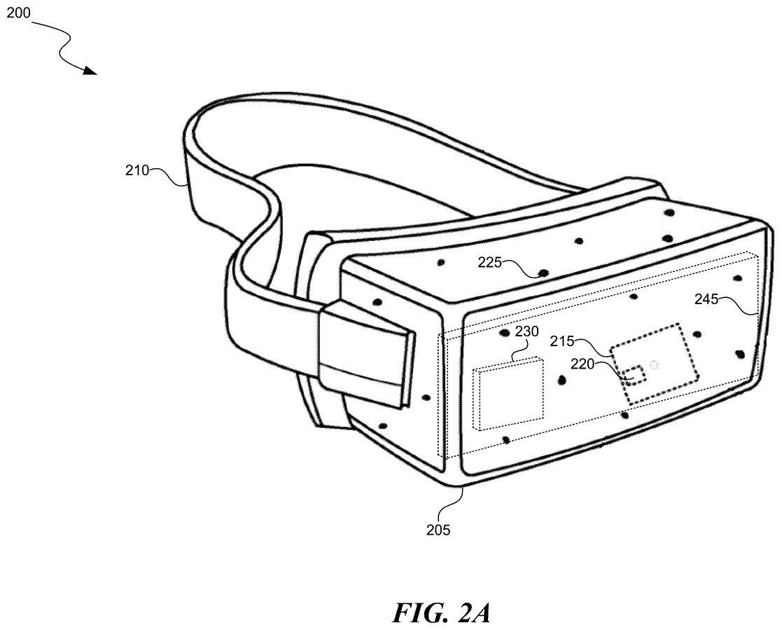

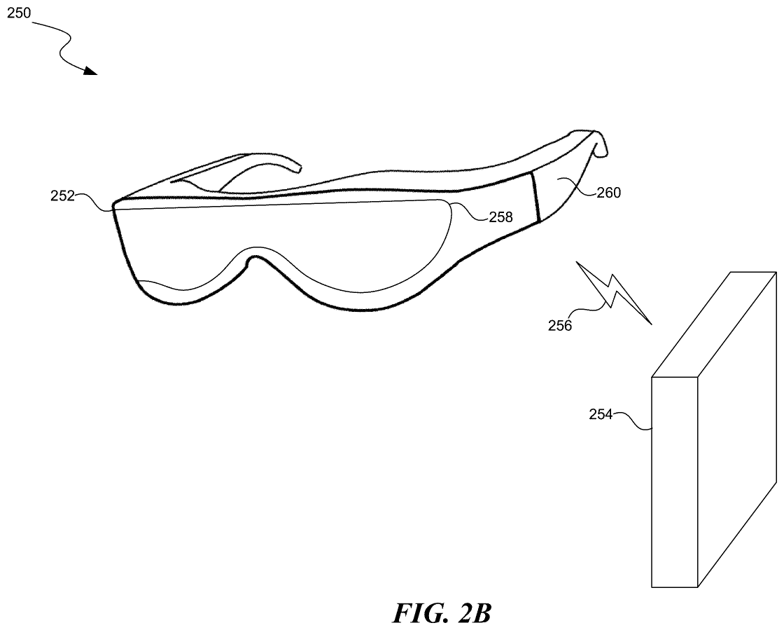

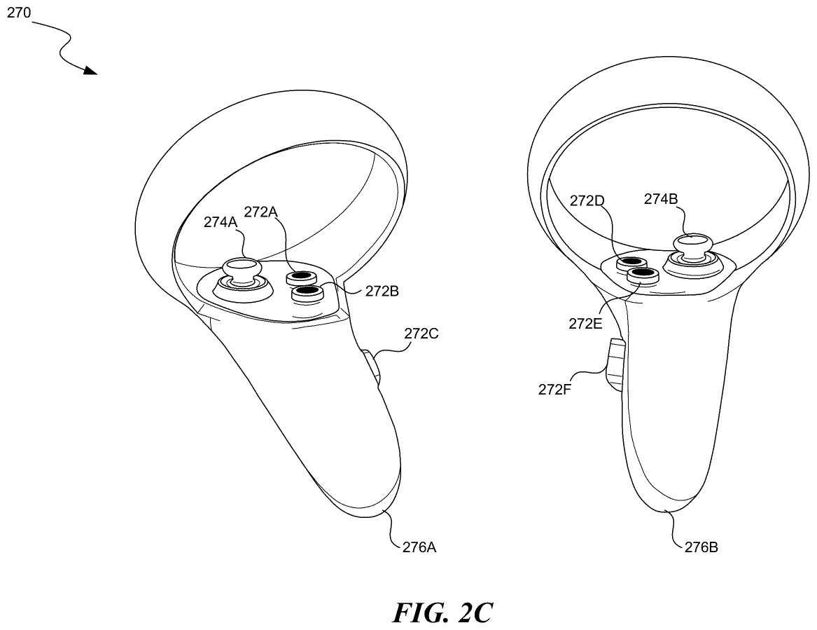

Several implementations are discussed below in more detail in reference to the figures. FIG. 1 is a block diagram illustrating an overview of devices on which some implementations of the disclosed technology can operate. The devices can comprise hardware components of a computing system 100 that can provide a two-dimensional (2D) user interface (UI) content overlay for an artificial reality (XR) environment. In various implementations, computing system 100 can include a single computing device 103 or multiple computing devices (e.g., computing device 101, computing device 102, and computing device 103) that communicate over wired or wireless channels to distribute processing and share input data. In some implementations, computing system 100 can include a stand-alone headset capable of providing a computer created or augmented experience for a user without the need for external processing or sensors. In other implementations, computing system 100 can include multiple computing devices such as a headset and a core processing component (such as a console, mobile device, or server system) where some processing operations are performed on the headset and others are offloaded to the core processing component. Example headsets are described below in relation to FIGS. 2A and 2B. In some implementations, position and environment data can be gathered only by sensors incorporated in the headset device, while in other implementations one or more of the non-headset computing devices can include sensor components that can track environment or position data.

Computing system 100 can include one or more processor(s) 110 (e.g., central processing units (CPUs), graphical processing units (GPUs), holographic processing units (HPUs), etc.) Processors 110 can be a single processing unit or multiple processing units in a device or distributed across multiple devices (e.g., distributed across two or more of computing devices 101-103).

Computing system 100 can include one or more input devices 120 that provide input to the processors 110, notifying them of actions. The actions can be mediated by a hardware controller that interprets the signals received from the input device and communicates the information to the processors 110 using a communication protocol. Each input device 120 can include, for example, a mouse, a keyboard, a touchscreen, a touchpad, a wearable input device (e.g., a haptics glove, a bracelet, a ring, an earring, a necklace, a watch, etc.), a camera (or other light-based input device, e.g., an infrared sensor), a microphone, or other user input devices.

Processors 110 can be coupled to other hardware devices, for example, with the use of an internal or external bus, such as a PCI bus, SCSI bus, or wireless connection. The processors 110 can communicate with a hardware controller for devices, such as for a display 130. Display 130 can be used to display text and graphics. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network chip or card, video chip or card, audio chip or card, USB, firewire or other external device, camera, printer, speakers, CD-ROM drive, DVD drive, disk drive, etc.

In some implementations, input from the I/O devices 140, such as cameras, depth sensors, IMU sensor, GPS units, LiDAR or other time-of-flights sensors, etc. can be used by the computing system 100 to identify and map the physical environment of the user while tracking the user's location within that environment. This simultaneous localization and mapping (SLAM) system can generate maps (e.g., topologies, girds, etc.) for an area (which may be a room, building, outdoor space, etc.) and/or obtain maps previously generated by computing system 100 or another computing system that had mapped the area. The SLAM system can track the user within the area based on factors such as GPS data, matching identified objects and structures to mapped objects and structures, monitoring acceleration and other position changes, etc.

Computing system 100 can include a communication device capable of communicating wirelessly or wire-based with other local computing devices or a network node. The communication device can communicate with another device or a server through a network using, for example, TCP/IP protocols. Computing system 100 can utilize the communication device to distribute operations across multiple network devices.

The processors 110 can have access to a memory 150, which can be contained on one of the computing devices of computing system 100 or can be distributed across of the multiple computing devices of computing system 100 or other external devices. A memory includes one or more hardware devices for volatile or non-volatile storage, and can include both read-only and writable memory. For example, a memory can include one or more of random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 150 can include program memory 160 that stores programs and software, such as an operating system 162, 2D UI content overlay system 164, and other application programs 166. Memory 150 can also include data memory 170 that can include, e.g., XR application-generated data signals, system-generated data signals, data signal mapping data, UI card data, ranking data, organization data, rendering data, configuration data, settings, user options or preferences, etc., which can be provided to the program memory 160 or any element of the computing system 100.

Some implementations can be operational with numerous other computing system environments or configurations. Examples of computing systems, environments, and/or configurations that may be suitable for use with the technology include, but are not limited to, XR headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

FIG. 2A is a wire diagram of a virtual reality head-mounted display (HMD) 200, in accordance with some embodiments. The HMD 200 includes a front rigid body 205 and a band 210. The front rigid body 205 includes one or more electronic display elements of an electronic display 245, an inertial motion unit (IMU) 215, one or more position sensors 220, locators 225, and one or more compute units 230. The position sensors 220, the IMU 215, and compute units 230 may be internal to the HMD 200 and may not be visible to the user. In various implementations, the IMU 215, position sensors 220, and locators 225 can track movement and location of the HMD 200 in the real world and in an artificial reality environment in three degrees of freedom (3DoF) or six degrees of freedom (6DoF). For example, the locators 225 can emit infrared light beams which create light points on real objects around the HMD 200. As another example, the IMU 215 can include e.g., one or more accelerometers, gyroscopes, magnetometers, other non-camera-based position, force, or orientation sensors, or combinations thereof. One or more cameras (not shown) integrated with the HMD 200 can detect the light points. Compute units 230 in the HMD 200 can use the detected light points to extrapolate position and movement of the HMD 200 as well as to identify the shape and position of the real objects surrounding the HMD 200.

The electronic display 245 can be integrated with the front rigid body 205 and can provide image light to a user as dictated by the compute units 230. In various embodiments, the electronic display 245 can be a single electronic display or multiple electronic displays (e.g., a display for each user eye). Examples of the electronic display 245 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof.

In some implementations, the HMD 200 can be coupled to a core processing component such as a personal computer (PC) (not shown) and/or one or more external sensors (not shown). The external sensors can monitor the HMD 200 (e.g., via light emitted from the HMD 200) which the PC can use, in combination with output from the IMU 215 and position sensors 220, to determine the location and movement of the HMD 200.

FIG. 2B is a wire diagram of a mixed reality HMD system 250 which includes a mixed reality HMD 252 and a core processing component 254. The mixed reality HMD 252 and the core processing component 254 can communicate via a wireless connection (e.g., a 60 GHZ link) as indicated by link 256. In other implementations, the mixed reality system 250 includes a headset only, without an external compute device or includes other wired or wireless connections between the mixed reality HMD 252 and the core processing component 254. The mixed reality HMD 252 includes a pass-through display 258 and a frame 260. The frame 260 can house various electronic components (not shown) such as light projectors (e.g., LASERs, LEDs, etc.), cameras, eye-tracking sensors, MEMS components, networking components, etc.

The projectors can be coupled to the pass-through display 258, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 254 via link 256 to HMD 252. Controllers in the HMD 252 can convert the image data into light pulses from the projectors, which can be transmitted via the optical elements as output light to the user's eye. The output light can mix with light that passes through the display 258, allowing the output light to present virtual objects that appear as if they exist in the real world.

Similarly to the HMD 200, the HMD system 250 can also include motion and position tracking units, cameras, light sources, etc., which allow the HMD system 250 to, e.g., track itself in 3DoF or 6DoF, track portions of the user (e.g., hands, feet, head, or other body parts), map virtual objects to appear as stationary as the HMD 252 moves, and have virtual objects react to gestures and other real-world objects.

FIG. 2C illustrates controllers 270 (including controller 276A and 276B), which, in some implementations, a user can hold in one or both hands to interact with an artificial reality environment presented by the HMD 200 and/or HMD 250. The controllers 270 can be in communication with the HMDs, either directly or via an external device (e.g., core processing component 254). The controllers can have their own IMU units, position sensors, and/or can emit further light points. The HMD 200 or 250, external sensors, or sensors in the controllers can track these controller light points to determine the controller positions and/or orientations (e.g., to track the controllers in 3DoF or 6DoF). The compute units 230 in the HMD 200 or the core processing component 254 can use this tracking, in combination with IMU and position output, to monitor hand positions and motions of the user. The controllers can also include various buttons (e.g., buttons 272A-F) and/or joysticks (e.g., joysticks 274A-B), which a user can actuate to provide input and interact with objects.

In various implementations, the HMD 200 or 250 can also include additional subsystems, such as an eye tracking unit, an audio system, various network components, etc., to monitor indications of user interactions and intentions. For example, in some implementations, instead of or in addition to controllers, one or more cameras included in the HMD 200 or 250, or from external cameras, can monitor the positions and poses of the user's hands to determine gestures and other hand and body motions. As another example, one or more light sources can illuminate either or both of the user's eyes and the HMD 200 or 250 can use eye-facing cameras to capture a reflection of this light to determine eye position (e.g., based on set of reflections around the user's cornea), modeling the user's eye and determining a gaze direction.

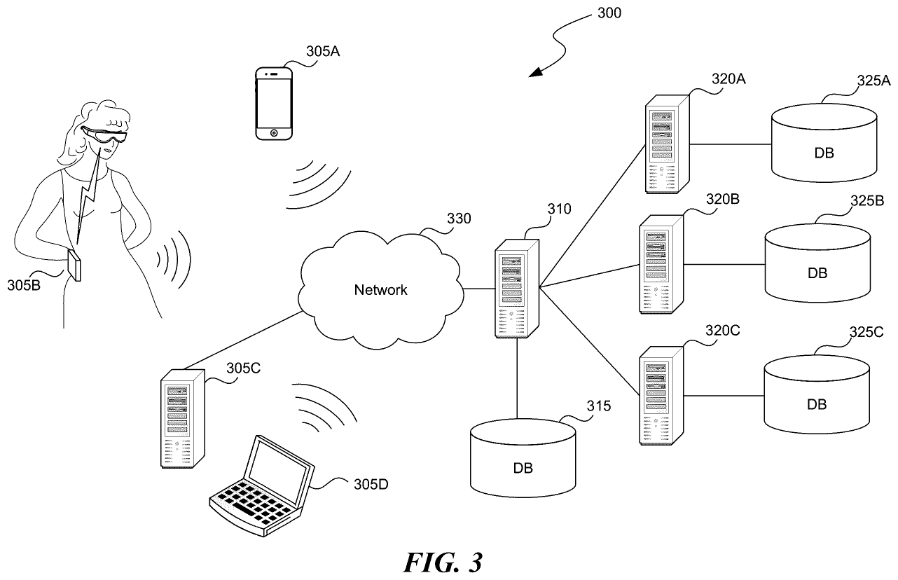

FIG. 3 is a block diagram illustrating an overview of an environment 300 in which some implementations of the disclosed technology can operate. Environment 300 can include one or more client computing devices 305A-D, examples of which can include computing system 100. In some implementations, some of the client computing devices (e.g., client computing device 305B) can be the HMD 200 or the HMD system 250. Client computing devices 305 can operate in a networked environment using logical connections through network 330 to one or more remote computers, such as a server computing device.

In some implementations, server 310 can be an edge server which receives client requests and coordinates fulfillment of those requests through other servers, such as servers 320A-C. Server computing devices 310 and 320 can comprise computing systems, such as computing system 100. Though each server computing device 310 and 320 is displayed logically as a single server, server computing devices can each be a distributed computing environment encompassing multiple computing devices located at the same or at geographically disparate physical locations.

Client computing devices 305 and server computing devices 310 and 320 can each act as a server or client to other server/client device(s). Server 310 can connect to a database 315. Servers 320A-C can each connect to a corresponding database 325A-C. As discussed above, each server 310 or 320 can correspond to a group of servers, and each of these servers can share a database or can have their own database. Though databases 315 and 325 are displayed logically as single units, databases 315 and 325 can each be a distributed computing environment encompassing multiple computing devices, can be located within their corresponding server, or can be located at the same or at geographically disparate physical locations.

Network 330 can be a local area network (LAN), a wide area network (WAN), a mesh network, a hybrid network, or other wired or wireless networks. Network 330 may be the Internet or some other public or private network. Client computing devices 305 can be connected to network 330 through a network interface, such as by wired or wireless communication. While the connections between server 310 and servers 320 are shown as separate connections, these connections can be any kind of local, wide area, wired, or wireless network, including network 330 or a separate public or private network.

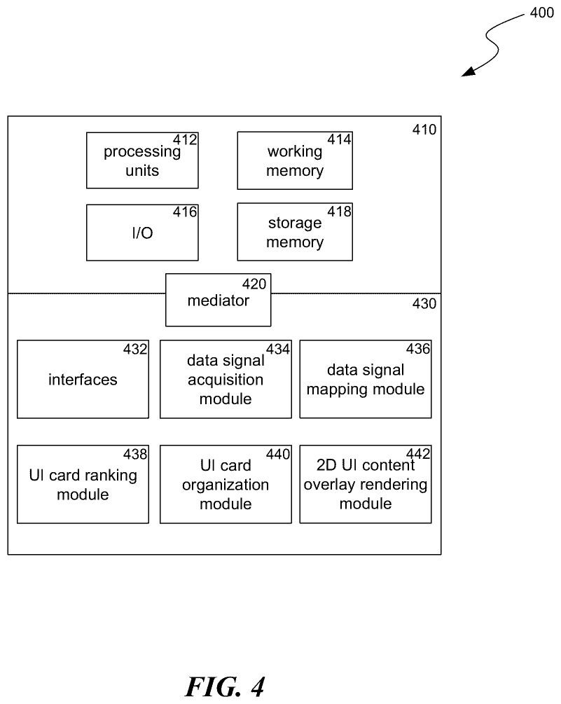

FIG. 4 is a block diagram illustrating components 400 which, in some implementations, can be used in a system employing the disclosed technology. Components 400 can be included in one device of computing system 100 or can be distributed across multiple of the devices of computing system 100. The components 400 include hardware 410, mediator 420, and specialized components 430. As discussed above, a system implementing the disclosed technology can use various hardware including processing units 412, working memory 414, input and output devices 416 (e.g., cameras, displays, IMU units, network connections, etc.), and storage memory 418. In various implementations, storage memory 418 can be one or more of: local devices, interfaces to remote storage devices, or combinations thereof. For example, storage memory 418 can be one or more hard drives or flash drives accessible through a system bus or can be a cloud storage provider (such as in storage 315 or 325) or other network storage accessible via one or more communications networks. In various implementations, components 400 can be implemented in a client computing device such as client computing devices 305 or on a server computing device, such as server computing device 310 or 320.

Mediator 420 can include components which mediate resources between hardware 410 and specialized components 430. For example, mediator 420 can include an operating system, services, drivers, a basic input output system (BIOS), controller circuits, or other hardware or software systems.

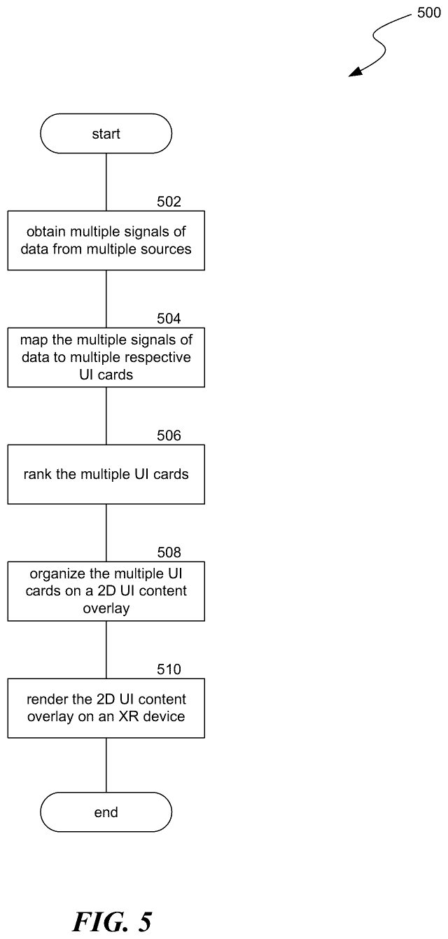

Specialized components 430 can include software or hardware configured to perform operations for providing a two-dimensional (2D) user interface (UI) content overlay for an artificial reality (XR) environment. Specialized components 430 can include data signal acquisition module 434, data signal mapping module 436, UI card ranking module 438, UI card organization module 440, 2D UI content overlay rendering module 442, and components and APIs which can be used for providing user interfaces, transferring data, and controlling the specialized components, such as interfaces 432. In some implementations, components 400 can be in a computing system that is distributed across multiple computing devices or can be an interface to a server-based application executing one or more of specialized components 430. Although depicted as separate components, specialized components 430 may be logical or other nonphysical differentiations of functions and/or may be submodules or code-blocks of one or more applications. In some implementations, specialized components 430 can execute process 500 of FIG. 5.

Data signal acquisition module 434 can obtain multiple signals of data from an XR application on an XR device and/or an XR system runtime executing on the XR device. The XR application can be executing on the XR device via an XR application runtime that controls the XR environment on the XR device (e.g., rendering a fully immersive VR environment, rendering an MR or AR environment including virtual objects overlaid on a view of a real-world environment surrounding the XR device, etc.). The XR system runtime can execute an operating system or shell application controlling system-level processes outside of the XR environment, such as system-level tools and functions not specific to the executing XR application, managing and/or interfacing with multiple XR application runtimes, collecting system-level data regarding the user and usage of the XR device, etc. The signals of data can include application-specific or system-level content. Further details regarding obtaining signals of data from an XR application and/or an XR system runtime are described herein with respect to block 502 of FIG. 5.

Data signal mapping module 436 can map, via the XR system runtime, the multiple signals of data obtained by data signal acquisition module 434 to multiple respective 2D user interface (UI) cards. In some implementations, the user interface cards can each include a template for 2D content. Data signal mapping module 436 can transform the signals of data into textual and/or graphical 2D content, and arrange the 2D content on the user interface cards according to the respective template. In some implementations, data signal mapping module 436 can access user interface cards for which no 2D content is available based on the signals of data. In such implementations, data signal mapping module 436 can remove such user interface cards from the set of user interface cards provided to UI card ranking module 438. Further details regarding mapping multiple signals of data to multiple respective user interface cards are described herein with respect to block 504 of FIG. 5.

UI card ranking module 438 can rank, via the XR system runtime, the multiple user interface cards mapped by data signal mapping module 436. In some implementations, UI card ranking module 438 can rank the user interface cards based on their content (e.g., type of content). In some implementations, UI card ranking module 438 can alternatively or additionally rank the user interface cards based on contextual factors, such as promoted or sponsored content, relevance of the content to the user, popularity of the content, time of day, user demographics data (e.g., age of user as compared to a suggested age for the content), etc., as described further herein. In some implementations, UI card ranking module 438 can rank the multiple user interface cards by applying a heuristic model to the content of the cards and/or to the contextual factors. In some implementations in which more accuracy is desired, however, UI card ranking module 438 can apply a machine learning model to the content of the cards and/or the contextual factors to predict a desired ranking, as described further herein. In some implementations, however, UI card ranking module 438 can rank the user interface cards randomly. Further details regarding ranking multiple user interface cards are described herein with respect to block 506 of FIG. 5.

UI card organization module 440, can organize, via the XR system runtime, the multiple user interface cards on a 2D UI content overlay based on the ranking established by UI card ranking module 438. For example, UI card organization module 440 can organize the user interface cards from left to right or top to bottom according to their ranking. Alternatively or additionally, UI card organization module 440 can organize the highest ranking cards on the initially rendered portion of the 2D UI content overly, such that the user must scroll to show the lower ranking cards. Alternatively or additionally, UI card organization module 440 can organize the cards more or less prominently according to their ranking, e.g., smaller or larger in size, at the center of the screen, highlighted or shadowed, etc. Further details regarding organizing multiple user interface cards on a 2D UI content overlay are described herein with respect to block 508 of FIG. 5.

2D UI content overlay rendering module 442 can render, via the XR system runtime, the 2D UI content overlay on the XR device. In some implementations, 2D UI content overlay rendering module 442 can render the 2D UI content overlay over the XR application as it is being rendered. In such implementations, 2D UI content overlay rendering module 442 can pause rendering and/or execution of the XR application in the background. As further signals of data are obtained by data signal acquisition module 434, mapped by data signal mapping module 436, and user interface cards are ranked by UI card ranking module 438 and organized by UI card organization module 440, 2D UI content overlay rendering module 442 can update the UI content overlay, such as by adding, removing, and/or replacing user interface cards rendered in the overlay. Further details regarding rendering a 2D UI content overlay on an XR device are described herein with respect to block 510 of FIG. 5.

Those skilled in the art will appreciate that the components illustrated in FIGS. 1-4 described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

FIG. 5 is a flow diagram illustrating a process 500 used in some implementations for providing a two-dimensional (2D) user interface (UI) content overlay for an artificial reality (XR) environment. In some implementations, process 500 can be performed as a response to a user, application, and/or system request to generate and/or display a 2D UI content overlay for an XR environment. In some implementations, process 500 can be performed by default upon activation or donning of an XR device and/or upon execution of an XR application. In some implementations, process 500 can be performed by one or more XR devices within an XR system, such as one or more of an XR HMD (e.g., XR HMD 200 of FIG. 2A and/or XR HMD 252 of FIG. 2B), one or more external processing components, etc. In some implementations, process 500 can be performed by 2D UI content overlay system 164 of FIG. 1.

At block 502, process 500 can obtain multiple signals of data from one or more sources. The one or more sources can include at least one of an XR application executing on the XR device via an XR application runtime or an XR system runtime executing on the XR device. In some implementations, the sources can include both the XR application and the XR system runtime. The XR application runtime can control the XR environment (e.g., an XR experience being executed and/or displayed on the XR device). The XR system runtime can execute an operating system on the XR device that controls system-level processes outside of the XR environment being executed, e.g., system tools, system options, user options, etc., that are either independent from XR applications or that aggregate functions across multiple XR applications.

At block 504, process 500 can map the multiple signals of data to multiple respective user interface cards. The user interface cards can be 2D cards including 2D templates for 2D content. Process 500 can select the user interface cards from multiple user interface cards based on eligibility, e.g., whether data signals received correspond to 2D content that is included in a template. The data signals can correspond to, for example, social data, avatar data, location data, activity data, achievement data, etc., as described further herein. For example, if no signals of data are received that are relevant to 2D content included in a particular card, that card can be eliminated from the set of eligible user interface cards. Conversely, if one or more signals of data are received that are relevant to 2D content included in a template, that card can be added to the set of eligible user interface cards. In some implementations, it is contemplated that multiple signals of data from one or more sources can be received that process 500 can map to a single user interface card.

In some implementations, the 2D content corresponding to the received data signals can be dynamic based on one or more contextual factors. The one or more contextual factors can include contextual data regarding a user (e.g., demographics data, data regarding a user's friends, etc.), contextual data regarding the XR application executing on the XR device (e.g., type of application, application usage information for the user, application usage information for other users, etc.), contextual data regarding actions taken by the user on the XR device (e.g., frequently or recently accessed XR applications, frequently or recently accessed system tools, etc.), contextual data regarding a system-level parameter of the XR device (e.g., time, battery power, processing power, display capabilities, available bandwidth, etc.), or any combination thereof.

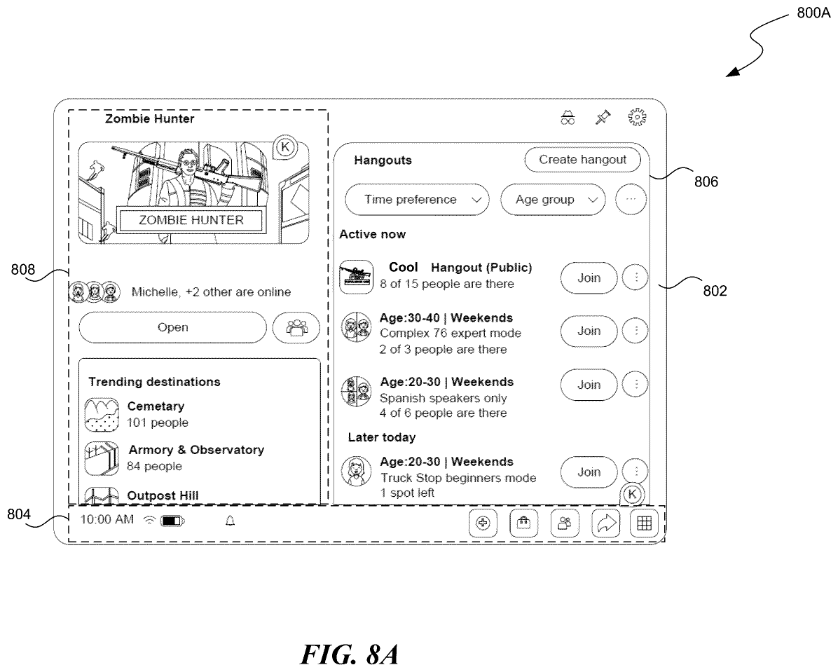

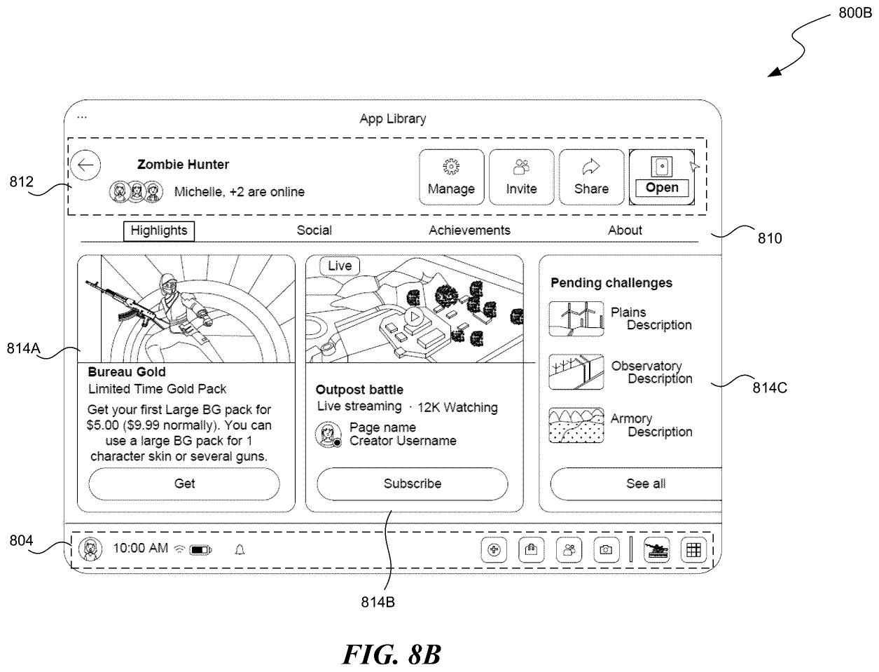

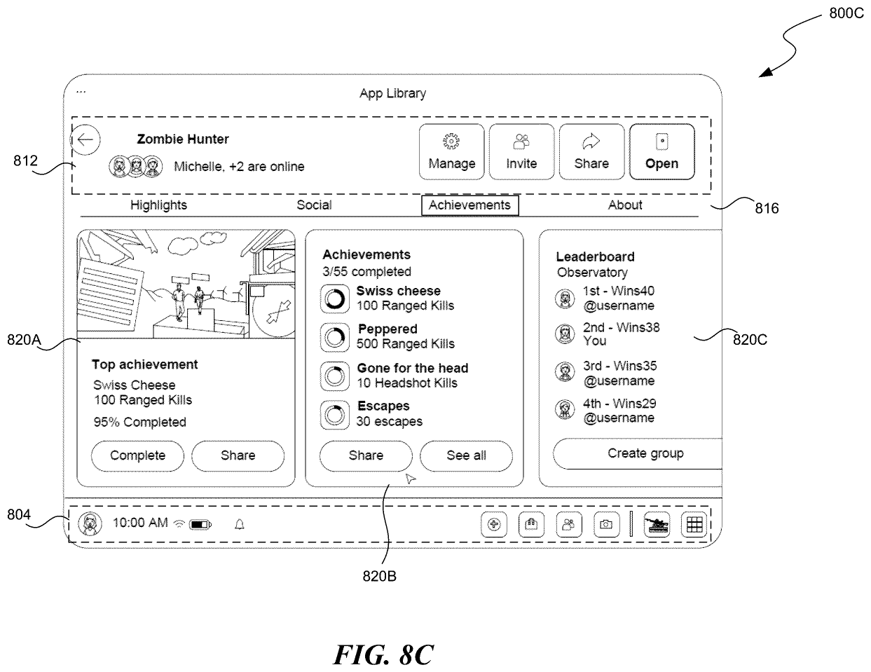

In some implementations, the user interface cards can include one or more suggested XR application cards. In some implementations, process 500 can select suggested XR application cards based on, for example, system-level data signals indicating frequently accessed XR applications, recently accessed XR applications, XR applications being executed by friends of the user, contextual data regarding XR applications (e.g., which XR applications are usually accessed at that time, a category of XR application such as productivity or gaming, etc.), XR applications accessed by similarly situated users (e.g., based on demographics other historical XR application usage data), etc. In some implementations, the suggested XR application cards can include a snapshot or preview of the XR application, an indicator of which (if any) friends are accessing the XR application, an option to execute the XR application, a list of available XR experiences (e.g., destinations) within the XR application, etc., which can be generated from data signals received from the XR system runtime and/or the XR application. An exemplary suggested XR application card is shown and described herein with respect to FIG. 8A.

In some implementations, the user interface cards can include one or more hangouts cards corresponding to social multi-user XR experiences. In some implementations, process 500 can generate hangouts cards based on, for example, system-level data signals indicating currently active hangouts, hangouts relevant to the user (e.g., based on demographics), hangouts starting at a particular time, hangouts accessed by a threshold number of users, maximum number of users for a particular hangout, etc. In some implementations, the hangouts cards can include a list of currently active hangouts, a list of later available hangouts, options to join hangouts, an option to create a hangout, filters for hangouts, data regarding particular hangouts (e.g., requirements to join the hangout, how many people are accessing the hangout, etc.), etc. An exemplary hangouts card is shown and described herein with respect to FIG. 8A.

In some implementations, the user interface cards can include one or more highlights cards. In some implementations, process 500 can generate highlights cards based on, for example, data signals received from an XR application indicating suggested or featured actions and/or events related to the XR application. The actions and/or events can be suggested or featured based on, for example, promotions related to the XR application, user demographics data, user usage data relative to the XR application, usage data of other users within the XR application, timing (e.g., current or future events), etc. Exemplary highlights cards are shown and described herein with respect to FIG. 8B.

In some implementations, the user interface cards can include one or more achievements cards. In some implementations, process 500 can generate achievements cards based on, for example, data signals received from an XR application indicating achievements made by the user and/or other users within the XR application. For example, the achievements cards can include the user's top achievement, a listing of all of the user's achievements, a leaderboard of users for the XR application (or for a group of users within an XR application, such as the user's friends, a public group, a private group, etc.), options to share achievements with others, options to create groups to compete against, etc. Exemplary achievements cards are shown and described herein with respect to FIG. 8C.

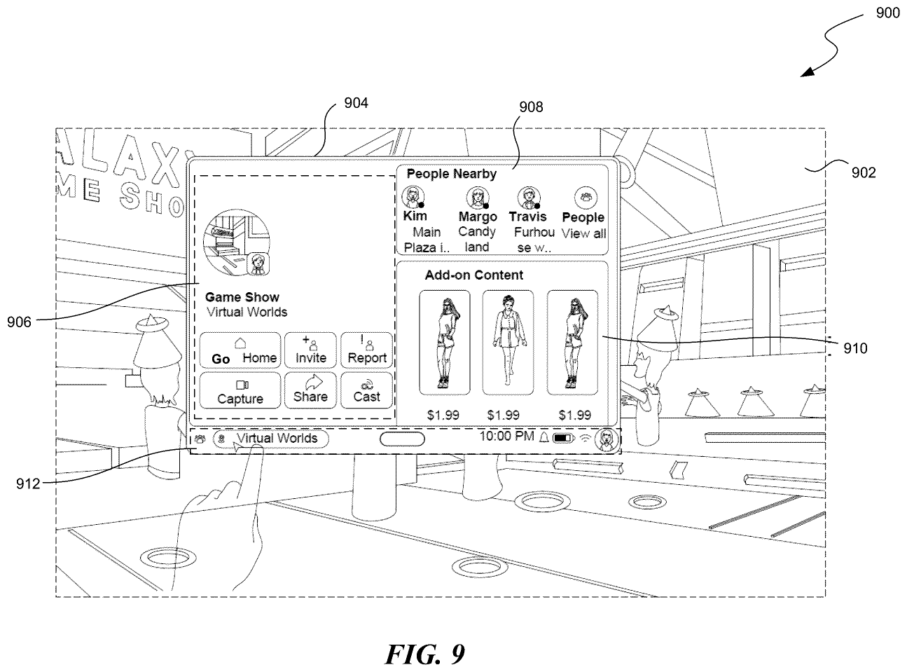

In some implementations, the user interface cards can include one or more social cards. The social cards can show avatars, names, usernames, virtual locations, and/or other data corresponding to: other users executing the XR application, other users executing other XR applications, online friends of the user, suggested friends of the user, users physically and/or virtually nearby (e.g., within a threshold physical distance or virtual distance), users having similar demographics, users having similar habits as far as XR applications historically accessed (and in some implementations, when), other users frequently encountered by the user, etc. In some implementations, when specific to an XR application (e.g., users in same XR application, users within a same instance of an XR application, etc.), the data signals corresponding to the social card can be provided by the XR application. In some implementations, the data signals corresponding to the social card can be provided by the XR system runtime in order to aggregate data from multiple XR applications and/or to provide system-level social data (e.g., users that are online, but not accessing a particular XR application). In some implementations, the social card can include a composite of social data received separately from the XR application and from the XR system runtime. An exemplary social card is shown and described herein with respect to FIG. 9.

In some implementations, the user interface cards can include one or more avatar cards. The avatar cards can show the current system-level avatar of the user, the avatar of the user for an executing XR application, different or the same avatars of the user across multiple XR applications, previous avatars used by the user, suggested or available avatar modifications for the user (either system-level or specific to an XR application), etc. In some implementations, when specific to an XR application (e.g., data regarding avatars used by the user within the XR application), the XR application can provide the data signals corresponding to the avatar card. In some implementations, the XR system runtime can provide the data signals corresponding to the avatar card (e.g., data regarding the user's system-level avatar, avatars used in other XR applications, etc.). In some implementations, the avatar card can include a composite of social data received separately from the XR application and from the XR system runtime. An exemplary avatar card is shown and described herein with respect to FIG. 9.

In some implementations, the user interface cards can include one or more system tools cards. The system tools cards can provide user interface elements corresponding to system-level functions and actions available for the user. In some implementations, the system tools cards can correspond to data or actions available to be performed within an executing XR application, such as joining a particular XR experience within an application, returning to a home screen, inviting a user to join an XR experience, reporting a user within an XR experience, capturing image and/or video data within an XR experience, sharing data from within an XR experience, or exiting the XR experience or application. An exemplary system tools card including functions available to be performed within an XR application is shown and described herein with respect to FIG. 9.

In some implementations, the system tools cards can correspond to system-level data and available actions, regardless of the XR application executing on the XR device. For example, the system tools cards can include a time display, a WiFi signal strength, a battery level, a notifications indicator, a messages indicator, an option to display a friends list, an option to access an application store, a settings option, etc. An exemplary system tools card including system-level data and available actions is shown and described herein with respect to FIGS. 8A-8C.

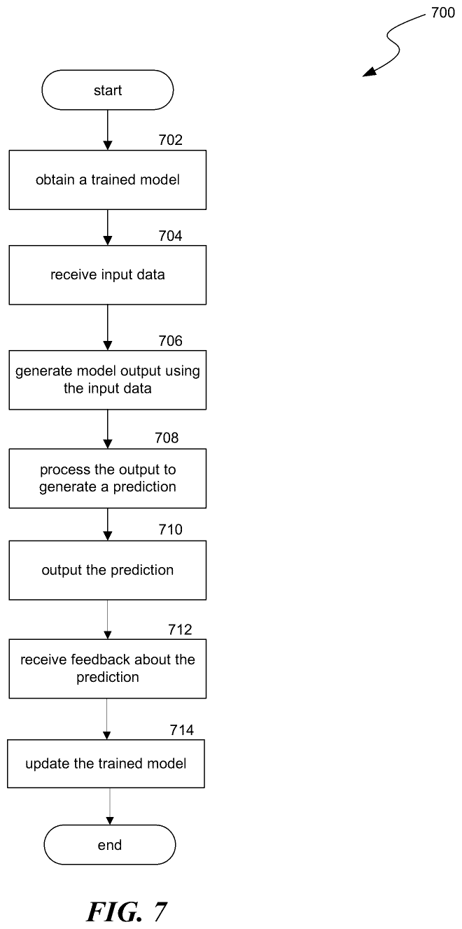

At block 506, process 500 can rank the multiple user interface cards. In some implementations, process 500 can rank the multiple user interface cards by applying a heuristic model to the multiple user interface cards and one or more contextual factors. The contextual factors can include data contextual to the user of the XR device (e.g., demographics data), data contextual to the application executing on the XR device (e.g., type or category of application, whether the application is single player or multiplayer, etc.), historical actions taken by the user on the XR device (e.g., applications accessed, system tools accessed, frequently performed actions, recently performed actions, time of day actions are taken, time of year actions are taken, etc.), a system-level parameter of the XR device (e.g., a current time, other functions executing on the XR device managed by the system-level runtime, system-level rules, processing power, battery level, etc.), and/or any of the other contextual factors described herein. By applying the heuristic model, the multiple user interface cards can be ranked quickly, and process 500 can proceed toward organizing the cards on the 2D UI content overlay in a manner that does not inhibit the user experience. In some implementations, however, it is contemplated that process 500 can alternatively rank the multiple user interface cards by applying a machine learning model to the cards and the contextual factors, as described further herein with respect to FIG. 7. In some implementations, process 500 can alternatively rank the multiple user interface cards randomly, without reference to the content of the user interface cards or any contextual factors.

At block 508, process 500 can organize the multiple user interface cards on the 2D UI content overlay based on the ranking. For example, based on the ranking of the user interface cards, process 500 can organize the user interface cards in order (e.g., from the highest ranked to the lowest ranked from left to right, with an option to scroll to show more if sufficient space is not available on the overlay). In another example, based on the ranking of the user interface cards, process 500 can display the higher ranked cards more prominently than the lower ranked cards (e.g., occupying a larger portion of the overlay than lower ranked cards). In some implementations, process 500 can alternatively or additionally organize the user interface cards according to an amount of 2D content within the cards (e.g., cards with more content can be larger than cards with less content).

At block 510, process 500 can render the 2D UI content overlay on the XR device. In some implementations in which the executing XR application is being rendered on the XR device, process 500 can render the 2D UI content overlay over the XR application. In some implementations, process 500 can pause execution and/or rendering of updates to the XR application while the 2D UI content overlay is being rendered. In some implementations, the 2D UI content overlay can be unique to the XR device (e.g., the content overlay is not duplicated in its same form on other XR devices).

In some implementations, the 2D UI context overlay can include a composite of user interface cards created using data signals from the XR application runtime and the XR system runtime. As noted above, in some implementations, individual user interface cards can further include a composite of 2D content created using data signals from the XR application runtime and the XR system runtime. In some implementations, as further signals of data are received from the XR application runtime and/or the XR system runtime, process 500 can update the 2D UI content overlay based on the further signals of data.

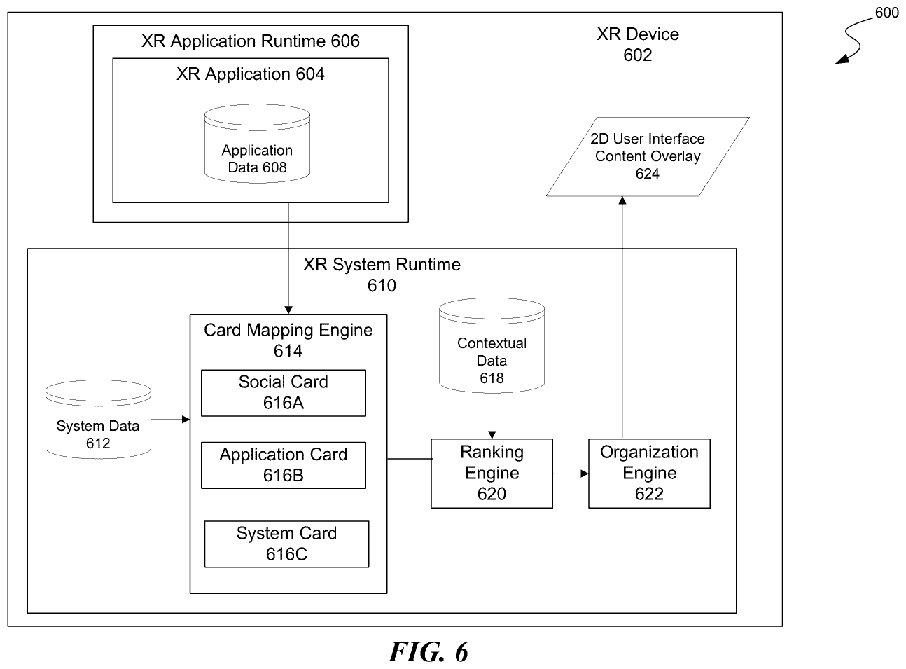

FIG. 6 is a block diagram illustrating a system 600 of inputs to and outputs from an artificial reality (XR) system runtime 610, executing on an XR device 602, to provide a two-dimensional (2D) user interface (UI) content overlay 624 for an XR application 604. XR application runtime 606 can be executing XR application 604 in order to control an XR environment rendered on XR device 602. XR application 604 can have application data 608 that can be provided in the form of application-specific data signals to card mapping engine 614 of XR system runtime 610. The application-specific data signals can include data describing XR application 604, a preview or snapshot of XR application 604, avatar data for a user of XR device 602 within XR application 604, a level and/or other achievements within XR application 604, other users accessing XR application 604 on other XR devices, events within XR application 604, promotions within XR application 604, or any combination thereof, as described further herein.

XR system runtime 610 can further obtain system data 612 that can further be provided to card mapping engine 614 in the form of system-level data signals. The system-level data signals can include social data regarding friends of the user of XR device 602 or other users on other XR devices, system tool data (e.g., time, timers, battery level, signal strength, camera data, etc.), location data of the user of XR device 602 and/or other users on other XR devices (e.g., virtual or physical location), suggested XR application or XR experience data, contextual data, or any combination thereof, as described further herein.

Card mapping engine 614 can perform the same or similar functions as data signal mapping module 436 of FIG. 4 in some implementations. Based on application data 608 and system data 612, card mapping engine 614 can identify eligible user interface cards having templates matching the available data. For example, card mapping engine 614 can map application data 608 and system data 612 to social card 616A, application card 616B, and system card 616C. Card mapping engine 614 can provide social card 616A, application card 616B, and system card 616C to ranking engine 620.

Ranking engine 620 can perform the same or similar functions as UI card ranking module 438 of FIG. 4 in some implementations. Ranking engine 620 can receive social card 616A, application card 616B, and system card 616C from card mapping engine 614, as well as contextual data 618 in some implementations. Contextual data 618 can include any user- or system-related contextual factors, such as user demographics, time of day (season, time of year, etc.), weather, XR applications executed by the user, XR applications executed by similarly situated users, popular XR applications, purchase history of the user, available processing power, available storage, battery level, historical actions taken by the user on the XR device, etc. In some implementations, XR application 604 can further provide application-specific contextual data (not shown) to ranking engine 620. Ranking engine 620 can apply a model to social card 616A, application card 616B, system card 616C, and contextual data 618 to rank social card 616A, application card 616B, and system card 616C according to relevance, popularity, promotions, and/or any other contextual factors, and/or based on the content of social card 616A, application card 616B, and system card 616C. In some implementations, ranking engine 620 can apply a heuristic or machine learning model to generate the ranking, and provide the ranked social card 616A, application card 616B, and system card 616C to organization engine 622.

Organization engine 622 can perform the same or similar functions as UI card organization module 440 of FIG. 4. Organization engine 622 can receive the ranked social card 616A, application card 616B, and system card 616C from ranking engine 620 and organize them on 2D UI content overlay 624 according to the ranking. For example, organization engine 622 can organize the highest ranked card on 2D UI content overlay 624 such that it is displayed first, most prominently, highlighted, larger, etc., relative to the lower ranked cards, and so on and so forth with the lower ranked cards. Organization engine 622 can then output 2D user interface content overlay 624 on XR device 602. By taking into account application data 608, system data 612, and/or contextual data 618, 2D user interface content overlay 624 can be customized for a user of XR device 602.

FIG. 7 is a flow diagram illustrating a process 700 used in some implementations for locally applying and updating a trained model for ranking user interface cards according to some implementations of the present technology. In some implementations, process 700 can be performed as a response to receiving user interface cards including 2D content to which obtained data signals were received and mapped. In some implementations, process 700 can be performed as a sub-process of block 506 of FIG. 5. In some implementations, process 700 can be performed by an XR system, the XR system including one or more XR devices (e.g., an XR HMD, one or more controllers, and/or one or more external processing components). In some implementations, process 700 can be performed by 2D UI content overlay system 164.

At block 702, process 700 can receive a trained model. In some implementations, the received model can be initially trained on ranked user interface cards having 2D content therein. In some implementations, the trained model can further be trained on feedback confirming that the predicted ranking was accurate, such as through user interaction with the ranked user interface cards or other user feedback regarding the ranking. In some implementations, process 700 can receive an updated machine learning model, such as when process 700 is performed iteratively.

At block 704, process 700 can receive input data. In some implementations, the input data can include newly generated 2D user interface cards including 2D content. In some implementations, the input data can further include contextual factors surrounding the 2D user interface cards and/or the 2D content. The contextual factors can include system-level data (e.g., time, processing power, available storage, battery power, system-level events, etc.), user data (e.g., demographics data), XR application data (e.g., type of XR application, whether the XR application is single player or multiplayer, etc.), historical actions taken by the user on the XR device, and/or any of the other contextual factors described herein, such as popularity of an XR application or user interface card, available promotions relative to a system or XR application function, relevance of content to the user, etc. For example, process 700 can capture and/or obtain the input data and/or contextual factors via the XR application runtime and/or via the XR system runtime.

At block 706, process 700 can generate a model output using the input data (e.g., the 2D user interface cards) and the trained model. In some implementations, process 700 can further generate the model output using any contextual factors. In some implementations, based on the input data, process 700 can extract relevant features from the input data (e.g., type of card, type of 2D content, amount of 2D content, etc.) and map the features as data points to an output vector in a classification space created using the training data.

At block 708, process 700 can process the model output to generate a predicted ranking based, at least partially, on the input user interface cards. In some implementations, process 700 can generate a match score between the output (e.g., the mapped features of the input data) and the features of candidate ranking data from the training data in the classification space by calculating a distance between the output and the candidate ranking data. The match score can be any numerical or textual value or indicator, such as a statistic or percentage. Process 700 can identify the predicted ranking data based on, for example, the candidate ranking data having the highest match score to the output.

At block 710, process 700 can output the prediction. In some implementations, process 700 can output the predicted ranking to a UI card organization module (e.g., UI card organization module 440 of FIG. 4, which, in some implementations, can perform block 508 of FIG. 5), which can organize the user interface cards onto a 2D UI content overlay rendered on the XR device. At block 712, process 700 can receive feedback about the predicted ranking. The feedback can be explicit or implicit, e.g., the user can reorganize or fail to reorganize the ranked user interface cards, the user can interact or not interact with the highest ranked user interface card, the user can close the 2D UI content overlay, etc.

At block 714, process 700 can update the trained model. For example, process 700 can use the feedback data to identify whether the predicted ranking (organized and displayed as the 2D UI content overlay) was correct or incorrect (and, if incorrect, what the correct ranking was), and use that information as a comparison factor to update the model and/or the classification space. In some implementations, process 700 can weigh the current training data more heavily than the initial or past training data, as the later training data can be considered more relevant and/or accurate. Although illustrated as a single process 700 in FIG. 7, it is contemplated that process 700 can be performed multiple times and/or repeatedly, either consecutively or concurrently, as additional input data is received.

Some implementations of the 2D UI content overlay system can include a machine learning component, such as a neural network, that is trained using a variety of data, including known input data, contextual factors, and whether the predicted card ranking was correct or incorrect. Some implementations can feed input data including multiple user interface cards and any contextual factors into the trained machine learning component, and based on the output, can generate a predicted ranking for the user interface cards. Some implementations provide this predicted ranking to a user via a graphical user interface on a display, such as via a 2D UI content overlay. Some implementations receive feedback about the predicted ranking to further enhance the trained model.

A “machine learning model,” as used herein, refers to a construct that is trained using training data to make predictions or provide probabilities for new data items, whether or not the new data items were included in the training data. For example, training data for supervised learning can include items with various parameters and an assigned classification. A new data item can have parameters that a model can use to assign a classification to the new data item. As another example, a model can be a probability distribution resulting from the analysis of training data, such as a likelihood of an n-gram occurring in a given language based on an analysis of a large corpus from that language. Examples of models include: neural networks, support vector machines, decision trees, Parzen windows, Bayes, clustering, reinforcement learning, probability distributions, decision trees, decision tree forests, and others. Models can be configured for various situations, data types, sources, and output formats.

In some implementations, the trained model can be a neural network with multiple input nodes that receive input data including multiple 2D user interface cards and any contextual factors. The input nodes can correspond to functions that receive the input and produce results. These results can be provided to one or more levels of intermediate nodes that each produce further results based on a combination of lower-level node results. A weighting factor can be applied to the output of each node before the result is passed to the next layer node. At a final layer, (“the output layer,”) one or more nodes can produce a value classifying the input that, once the model is trained, can be used to predict a ranking for the 2D user interface cards. In some implementations, such neural networks, known as deep neural networks, can have multiple layers of intermediate nodes with different configurations, can be a combination of models that receive different parts of the input and/or input from other parts of the deep neural network, or are convolutions or recurrent-partially using output from previous iterations of applying the model as further input to produce results for the current input.

A machine learning model can be trained with supervised learning, where the training data includes known input data and any contextual factors and a desired output, such as a predicted ranking for 2D user interface cards. Current input data (e.g., multiple 2D user interface cards) can be provided to the model. Output from the model can be compared to the desired output for that input data, and, based on the comparison, the model can be modified, such as by changing weights between nodes of the neural network or parameters of the functions used at each node in the neural network (e.g., applying a loss function). After applying each of the factors in the training data and modifying the model in this manner, the model can be trained to evaluate new input data.

Some implementations of the 2D UI content overlay system can include a deep learning component. A “deep learning model,” as used herein, refers to a construct trained to learn by example to perform classification directly from input data. The deep learning model is trained by using a large set of labeled data and applying a neural network as described above that includes many layers. The deep learning model in some implementations can be a convolutional neural network (CNN) that is used to automatically learn input data's inherent features to identify a predicted action. For example, the deep learning model can be an R-CNN, Fast R-CNN, or Faster-RCNN.

FIG. 8A is a conceptual diagram illustrating an example view 800A on an artificial reality (XR) device of a two-dimensional (2D) user interface (UI) content overlay 802 as a home screen. 2D UI content overlay 802 can include multiple user interface cards: system tools card 804, hangouts card 806, and suggested XR application card 808. System tools card 804 can be generated based on signals of data generated via the XR system runtime, and can include user interface elements corresponding to system-level functions and actions available to the user that are not associated with a particular XR application. For example, system tools card 808 can include a time, a WiFi signal strength, a current battery level, an option to go to an application store, an option to share content, an option to view a friends list, etc., as shown in view 800A.

Suggested XR application card 808 can be generated based a system-level data signal indicating, for example, that “Zombie Hunter” is frequently accessed by the user of the XR device (or frequently accessed by the user at this particular time of day), that it was the last accessed XR application, that it is being executed by friends of the user, that it is popular or trending, that it is sponsored, etc. Suggested XR application card 808 can further include content based on data signals received via the XR application runtime. For example, suggested XR application card 808 can include a snapshot of the XR application, a listing of which friends are accessing the XR application, an option to launch the XR application, trending destinations with the XR application, etc.

Hangouts card 806 can correspond to social multi-user XR experiences. Hangouts card 806 can be generated based on system-level data signals indicating, for example, currently active hangouts and later scheduled hangouts, as shown in view 800A. Hangouts card 806 can further include an option to create a new hangout, options to join hangouts, filters for hangouts (e.g., time preference and age group), snapshots of the hangouts, descriptions of the hangouts, number of users in the hangouts, maximum number of users for the hangouts, etc.

FIG. 8B is a conceptual diagram illustrating an example view 800B on an artificial reality (XR) device of highlights cards 814A-814C in a two-dimensional (2D) user interface (UI) content overlay 810 for an XR application. Highlights card 814A can include, for example, a promotion relative to an XR application (e.g., the XR application indicated by suggested XR application card 812). Highlights card 814B can include a preview and option to join a live streaming XR experience within the XR application. Highlights card 814C can list pending challenges within the XR application. In some implementations, highlights cards 814A-81C can be arranged on 2D UI content overlay 810 according to a ranking. For example, highlights card 814A can be ranked first, while highlights card 814B can be ranked second, and highlights card 814C can be ranked third, and can be organized from left to right accordingly. Highlights cards 814A-814C can be ranked based on their content and/or contextual data, as described further herein. In some implementations, however, it is contemplated that highlights cards 814A-814C can be ranked randomly.

2D UI content overlay 810 can further include suggested XR application card 812, which can include a description of a suggested XR application and a listing of users accessing the XR application, as generated based on application-level data signals. Suggested XR application card 812 can further include system-level options, such as managing the XR application, inviting others to the XR application, sharing the XR application, or launching the XR application on the XR device. 2D UI content overlay 810 can further include system tools card 804, as described further herein with respect to FIG. 8A.

FIG. 8C is a conceptual diagram illustrating an example view 800C on an artificial reality (XR) device of achievements cards 820A-820C in a two-dimensional (2D) user interface (UI) content overlay 816 for an XR application. Achievements cards 820A-820C can be generated based on data signals received from the XR application. For example, achievements card 820A can include a top achievement, an option to complete the top achievement, and an option to share the top achievement. Achievements card 820B can include a list of achievements that can be completed relative to the XR application, as well as the user's status in those achievements. Achievements card 820C can include a leaderboard of a group of users within the XR application, and an option to create a new group of users to compete with. 2D UI content overlay 810 can further include system tools card 804, as described further herein with respect to FIG. 8A, and suggested XR application card 812 as described further herein with respect to FIG. 8B.

FIG. 9 is a conceptual diagram illustrating an example view 900 on an artificial reality (XR) device of a social card 908 and an avatar card 910 in a two-dimensional (2D) user interface (UI) content overlay 904 for an XR application 902. Social card 908 can be generated based on system-level data signals indicating users near the user of the XR device, either virtually or physically, and their respective locations. Avatar card 910 can be generated based on system- or application-level data signals indicating additional avatar content that can be purchased and used, either within XR application 902, for a global system-level avatar, and/or across multiple XR applications.

2D UI content overlay 904 can further include executing XR application card 906 which can provide system-level functions for XR application 902, such as to go home, to invite another user, to report a user, to capture an image or video, to share the XR application, or to cast the XR application, which can be managed by the XR application runtime, the XR system runtime, or both. 2D UI content overlay 904 can further include system tools card 912, which can provide access to system-level data, such as the time, battery level, WiFi signal strength, etc., as described further herein. In some implementations, rendering and/or execution of XR application 902 can be paused while 2D UI content overlay 904 is rendered on the XR device.

Reference in this specification to “implementations” (e.g., “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative mutually of other implementations exclusive implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method for providing a two-dimensional user interface content overlay in an artificial reality environment, the method comprising:
obtaining, by an artificial reality device, multiple signals of data from multiple sources, the multiple sources including A) an artificial reality application executing on the artificial reality device via an artificial reality application runtime, and B) an artificial reality system runtime executing on the artificial reality device,
wherein the artificial reality application runtime controls the artificial reality environment, and
wherein the artificial reality system runtime executes an operating system controlling system-level processes outside of the artificial reality environment;
mapping, via the artificial reality system runtime, the multiple signals of data to multiple respective user interface cards, the multiple user interface cards each including a two-dimensional template for two-dimensional content;
ranking, via the artificial reality system runtime, the multiple user interface cards;
organizing, via the artificial reality system runtime, the multiple user interface cards on the two-dimensional user interface content overlay based on the ranking; and
rendering, via the artificial reality system runtime, the two-dimensional user interface content overlay over the artificial reality application on the artificial reality device.

2. The method of claim 1, wherein the multiple user interface cards are ranked by applying a heuristic model to A) the multiple user interface cards and B) one or more contextual factors.

3. The method of claim 2, wherein the one or more contextual factors are contextual to at least one of a user of the artificial reality device, the artificial reality application executing one the artificial reality device, one or more historical actions taken by the user on the artificial reality device, a system-level parameter of the artificial reality device, or any combination thereof.

4. The method of claim 1, wherein the two-dimensional content is dynamic based on one or more contextual factors.

5. The method of claim 1, wherein the multiple user interface cards are selected based on one or more types of data within the multiple signals of data, the one or more types of data including at least one of social data, avatar data, location data, activity data, achievement data, or any combination thereof.

6. The method of claim 1, wherein the ranking the multiple user interface cards includes applying a randomization ordering among at least some of the multiple user interface cards.

7. The method of claim 1, further comprising:
obtaining further signals of data from at least one of multiple sources; and
updating the two-dimensional user interface content overlay based on the further signals of data.

8. The method of claim 1, further comprising:
pausing the artificial reality application executing on the artificial reality device while the two-dimensional user interface content overlay is rendered.

9. The method of claim 1, wherein the two-dimensional user interface content overlay, rendered by the artificial reality device, is customized for a user of the artificial reality device.

10. A computer-readable storage medium storing instructions that, when executed by a computing system, cause the computing system to perform a process for providing a two-dimensional user interface content overlay in an artificial reality environment, the process comprising:
obtaining, by an artificial reality device, multiple signals of data from one or more sources, the one or more sources including at least one of an artificial reality application executing on the artificial reality device via an artificial reality application runtime, an artificial reality system runtime executing on the artificial reality device, or both;
mapping, via the artificial reality system runtime, the multiple signals of data to multiple respective user interface cards, the multiple user interface cards each including a two-dimensional template for two-dimensional content;
ranking, via the artificial reality system runtime, the multiple user interface cards;
organizing, via the artificial reality system runtime, the multiple user interface cards on the two-dimensional user interface content overlay based on the ranking; and
rendering, via the artificial reality system runtime, the two-dimensional user interface content overlay on the artificial reality device.

11. The computer-readable storage medium of claim 10, wherein the one or more sources include both the artificial reality application and the artificial reality system runtime.

12. The computer-readable storage medium of claim 10,
wherein the artificial reality application runtime controls the artificial reality environment, and
wherein the artificial reality system runtime executes an operating system controlling system-level processes outside of the artificial reality environment.

13. The computer-readable storage medium of claim 12, wherein the multiple user interface cards are ranked by applying a heuristic model to A) the multiple user interface cards and B) one or more contextual factors.

14. The computer-readable storage medium of claim 13, wherein the one or more contextual factors are contextual to at least one of a user of the artificial reality device, the artificial reality application executing one the artificial reality device, one or more historical actions taken by the user on the artificial reality device, a system-level parameter of the artificial reality device, or any combination thereof.

15. The computer-readable storage medium of claim 13, wherein the two-dimensional content is dynamic based on the one or more contextual factors.

16. A computing system for providing a two-dimensional user interface content overlay for an artificial reality environment, the computing system comprising:
one or more processors; and
one or more memories storing instructions that, when executed by the one or more processors, cause the computing system to perform a process comprising:
obtaining, by an artificial reality device, multiple signals of data from one or more sources, the one or more sources including at least one of an artificial reality application executing on the artificial reality device via an artificial reality application runtime, an artificial reality system runtime executing on the artificial reality device, or both;
mapping, via the artificial reality system runtime, the multiple signals of data to multiple respective user interface cards, the multiple user interface cards each including a two-dimensional template for two-dimensional content;
ranking, via the artificial reality system runtime, the multiple user interface cards;
organizing, via the artificial reality system runtime, the multiple user interface cards on the two-dimensional user interface content overlay based on the ranking; and
rendering, via the artificial reality system runtime, the two-dimensional user interface content overlay on the artificial reality device.

17. The computing system of claim 16,
wherein the one or more sources include both the artificial reality application and the artificial reality system runtime,
wherein the artificial reality application runtime controls the artificial reality environment, and
wherein the artificial reality system runtime executes an operating system controlling system-level processes outside of the artificial reality environment.

18. The computing system of claim 16, wherein the ranking the multiple user interface cards includes applying a randomization ordering among at least some of the multiple user interface cards.

19. The computing system of claim 16, wherein the process further comprises:
obtaining further signals of data from at least one of the one or more sources; and
updating the two-dimensional user interface content overlay based on the further signals of data.

20. The computing system of claim 16, wherein the process further comprises:
pausing the artificial reality application executing on the artificial reality device while the two-dimensional user interface content overlay is rendered.
